(19) United States
(12) Patent Application Publication
(10) Pub. No.: US 2025/0159521 A1
(43) Pub. Date: May 15, 2025

(54) COMMUNICATION METHOD AND APPARATUS, AND ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/728,547

(22) PCT Filed: Jan. 14, 2022
(86) PCT No.: PCT/CN2022/072080

§ 371 Date: Jul. 12, 2024

(51) Int. Cl. H04W 24/10; H04W 84/12

(52) U.S. Cl. CPC H04W 24/10; H04W 84/12

(57) ABSTRACT

The embodiments of the present disclosure provide communication methods and apparatuses, and electronic devices and storage medium. One of the communication methods includes sending a first wireless frame, wherein the first wireless frame includes first sensing proxy information. The first sensing proxy information indicates whether a station (STA) supports a wireless local area network (WLAN) sensing measurement performed by a proxy device on behalf of the STA when the STA serves as a sensing initiator during the WLAN sensing measurement.

The present application is a U.S. National Stage of International Application No. PCT/CN2022/072080, filed on Jan. 14, 2022, the contents of all of which are incorporated herein by reference in their entireties for all purposes.

### TECHNICAL FIELD

The embodiments of the present disclosure relate to the field of mobile communication technology. Specifically, the embodiments of the present disclosure relate to a communication method and apparatus, an electronic device and a storage medium.

### BACKGROUND

With the rapid development of mobile communication technology, Wireless Fidelity (Wi-Fi) technology has made great progress in transmission rate and throughput. At present, the content studied by Wi-Fi technology is such as 320 Mhz bandwidth transmission, aggregation and coordination of multiple frequency bands, etc. Its main application scenarios are such as video transmission, Augmented Reality (AR), Virtual Reality (VR), etc.

Among the currently studied Wi-Fi technologies, Wireless Local Area Network (WLAN) sensing technology may be supported, for example, application scenarios such as location discovery, proximity detection and presence detection in dense environment (such as home environment and corporate environment). In the process of WLAN sensing, the identities of the Station (STA) and the Access Point (AP) are usually interchangeable, for example, both can be used as the sensing initiator or sensing transmitter. When used as the sensing initiator or sensing transmitter, the AP can communicate with a plurality of STAs at the same time, but the STA does not have the above functions and can only communicate one-to-one with a single sensing responder. On the one hand, it causes waste of spectrum resources, and on the other hand, it causes increase in latency. For communication scenarios with high latency requirement, the latency requirement may not be met.

### SUMMARY

The embodiments of the present disclosure provide a communication method and apparatus, an electronic device and a storage medium.

The embodiments of the present disclosure provide a communication method, performed by a station (STA). The method includes sending a first wireless frame, wherein the first wireless frame includes first sensing proxy information. The first sensing proxy information indicates whether the STA supports a wireless local area network (WLAN) sensing measurement performed by a proxy device of the STA when the STA serves as a sensing initiator during the WLAN sensing measurement.

The embodiments of the present disclosure further provide a communication method, performed by an access point (AP). The method includes sending a second wireless frame, wherein the second wireless frame includes second sensing proxy information. The second sensing proxy information indicates whether the AP supports to perform a WLAN sensing measurement as a proxy device of an STA during the WLAN sensing measurement.

The embodiments of the present disclosure further provide an STA including a first sending module configured to send a first wireless frame, wherein the first wireless frame includes first sensing proxy information. The first sensing proxy information indicates whether the STA supports a WLAN sensing measurement performed by a proxy device of the STA when the STA serves as a sensing initiator during the WLAN sensing measurement.

The embodiments of the present disclosure further provide an AP including a third sending module configured to send a second wireless frame, wherein the second wireless frame includes second sensing proxy information. The second sensing proxy information indicates whether the AP supports to perform a WLAN sensing measurement as a proxy device of an STA during the WLAN sensing measurement.

The embodiments of the present disclosure further provide a communication apparatus, applied to an STA. The apparatus includes a fourth sending module configured to send a first wireless frame, wherein the first wireless frame includes first sensing proxy information. The first sensing proxy information indicates whether the STA supports a WLAN sensing measurement performed by a proxy device of the STA when the STA serves as a sensing initiator during the WLAN sensing measurement.

The embodiments of the present disclosure further provide a communication apparatus, applied to an AP. The apparatus includes a fifth sending module configured to send a second wireless frame, wherein the second wireless frame includes second sensing proxy information. The second sensing proxy information indicates whether the AP supports to perform a WLAN sensing measurement as a proxy device of an STA during the WLAN sensing measurement.

The embodiments of the present disclosure further provide an electronic device, including a memory, a processor, and a computer program stored on the memory and executable on the processor, wherein the processor implements one or more methods in the embodiments of the present disclosure when executing the program.

The embodiments of the present disclosure further provide a non-transitory computer-readable storage medium, wherein a computer program is stored on the non-transitory computer-readable storage medium, and the computer program implements one or more methods in the embodiments of the present disclosure when executed by the processor.

Additional aspects and advantages of embodiments of the present disclosure will be partially given in the following description, which will become obvious from the following description or be understood through the practice of the present disclosure.

### BRIEF DESCRIPTION OF THE DRAWINGS

In order to more clearly illustrate the technical solutions of the embodiments of the present disclosure, the drawings required for use in the description of the embodiments of the present disclosure will be briefly introduced below. The drawings in the following description are only some embodiments of the present disclosure. For ordinary technicians in this field, other drawings can also be obtained based on these drawings without paying creative labor.

FIG. 1 is a first flowchart of a communication method provided by an embodiment of the present disclosure;

FIG. 2 is a first schematic diagram of a first example of an embodiment of the present disclosure:

FIG. 3 is a second schematic diagram of a first example of the first example of an embodiment of the present disclosure:

FIG. 4 is a third schematic diagram of a first example of the first example of an embodiment of the present disclosure;

FIG. 5 is a second flowchart of a communication method provided by an embodiment of the present disclosure;

FIG. 6 is a third flowchart of a communication method provided by an embodiment of the present disclosure:

FIG. 7 is a fourth flowchart of a communication method provided by an embodiment of the present disclosure:

FIG. 8 is a fifth flowchart of a communication method provided by an embodiment of the present disclosure:

FIG. 9 is a sixth flowchart of a communication method provided by an embodiment of the present disclosure:

FIG. 10 is a first schematic diagram of a structure of a communication apparatus provided by an embodiment of the present disclosure:

FIG. 11 is a second schematic diagram of a structure of a communication apparatus provided by an embodiment of the present disclosure; and

FIG. 12 is a schematic diagram of a structure of an electronic device provided by an embodiment of the present disclosure.

### DETAILED DESCRIPTION

In the embodiments of the present disclosure, the term “and/or” describes the association relationship of associated objects, indicating that there may be three relationships. For example, A and/or B may represent: A exists alone, A and B exist at the same time, and B exists alone. The character “/” generally indicates that the associated objects before and after it are in an “or” relationship.

In the embodiments of the present disclosure, the term “multiple/a plurality of” refers to two or more, and other quantifiers are similar.

Here, the example embodiments will be described in detail, and examples thereof are shown in the accompanying drawings. Unless otherwise indicated, the same numbers in different drawings represent the same or similar elements when the following description refers to the drawings. The implementations described in the following example embodiments do not represent all implementations consistent with the present disclosure. Instead, they are only examples of apparatuses and methods consistent with some aspects of the present disclosure as detailed in the appended claims.

The terms used in the present disclosure are only for the purpose of describing specific embodiments and are not intended to limit the present disclosure. The singular forms “one”, “said” and “the” used in the present disclosure and the appended claims are also intended to include plural forms, unless the context clearly indicates otherwise. It should also be understood that, the term “and/or” used herein refers to and includes any or all possible combinations of one or more associated listed items.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, for example, the word “if” used herein may be interpreted as “at . . . ” or “when . . . ” or “in response to determining”.

The technical solutions in the embodiments of the present disclosure will be described clearly and completely below in conjunction with the drawings in the embodiments of the present disclosure. The described embodiments are only part of the embodiments of the present disclosure, not all embodiments. Based on the embodiments in the present disclosure, all other embodiments obtained by ordinary technicians in the field without creative work are within the scope of protection of the present disclosure.

The embodiments of the present disclosure provide a communication method and apparatus, an electronic device and a storage medium, to improve the measurement process of the AP initiating sensing measurement as a proxy of STA.

The method and the apparatus are based on the same application concept. Since the principles of solving the problem by the method and the apparatus are similar, the implementation of the apparatus and the method can refer to each other, and the repetitions will not be repeated.

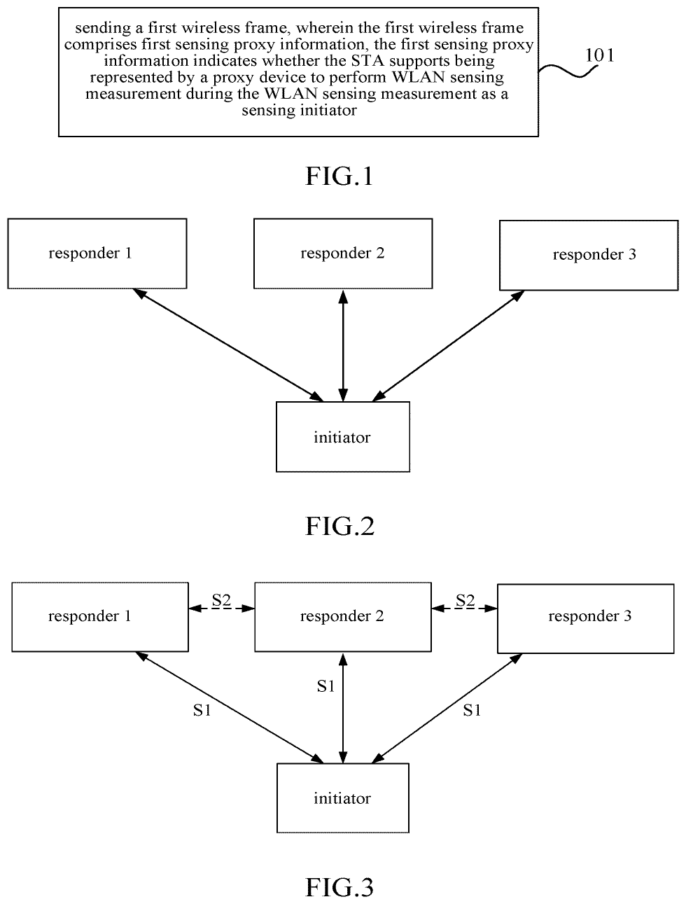

As shown in FIG. 1, the embodiment of the present disclosure provides a communication method. Optionally, the method can be applied to a Station (STA) and can include the following steps:

step 101, sending a first wireless frame, wherein the first wireless frame includes first sensing proxy information, the first sensing proxy information indicates whether the STA supports being represented by a proxy device to perform WLAN sensing measurement during the WLAN sensing measurement as a sensing initiator.

As a first example, referring to FIG. 2 to FIG. 4, the architecture of WLAN sensing and the WLAN sensing process applied by the communication method provided in the embodiments of the present disclosure are first introduced.

FIG. 2 shows a schematic diagram of the architecture of WLAN sensing (process). The sensing initiator (or initiator) initiates WLAN sensing (for example, initiates a WLAN sensing session), and there may be a plurality of sensing responders (or sensing receivers) or responders responding to it, shown as responder 1, responder 2 and responder 3 in FIG. 2. When the sensing initiator initiates WLAN sensing, a plurality of associated or unassociated sensing responders of WLAN sensing can respond.

Referring to FIG. 3, the sensing initiator communicates with the sensing responder through a communication connection, for example, the communication connection S1. The sensing responders communicate with each other through communication connection S2.

Each sensing initiator can be a Client, and each sensing responder (in this example, sensing responder 1 to sensing responder 3) can be a station (STA) or an access point AP. In addition, STA and AP can undertake multiple roles in the WLAN sensing process. For example, in the WLAN sensing process, STA can also serve as a sensing initiator, and the sensing initiator may be a sensing transmitter, a sensing receiver, or both, or neither. In the WLAN sensing process, the sensing responder may also be a sensing transmitter, a sensing receiver, or both.

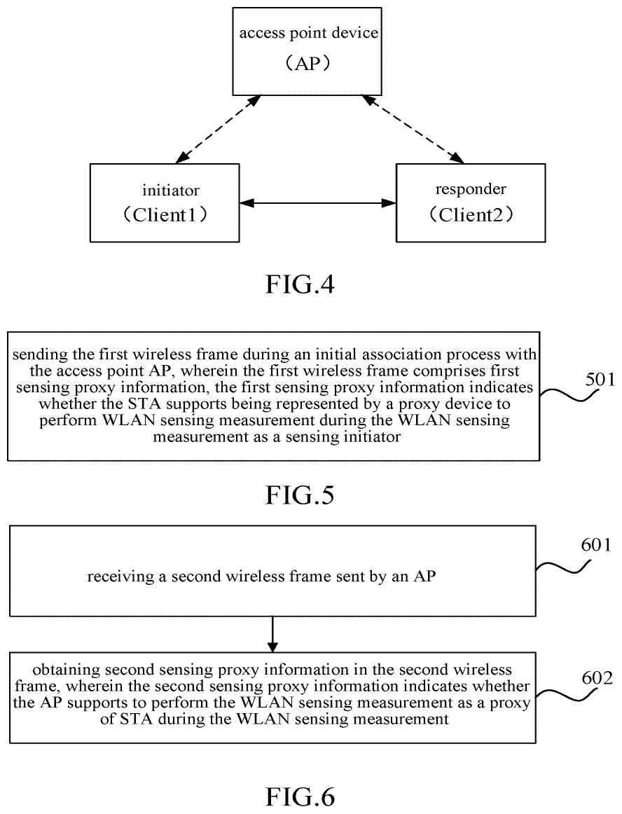

As another architecture, as shown in FIG. 4, the sensing initiator and the sensing responder may also be clients, and the two can communicate by connecting to the same access point (AP). Client 1 in FIG. 4 is the sensing initiator, and Client 2 is the sensing responder.

The proxy device performing WLAN sensing measurement as a proxy of STA may include at least one of proxy downlink sensing measurement and proxy uplink sensing measurement. The proxy downlink sensing measurement is such as the proxy device (such as AP) sending an NDPA frame and then sending an NDP frame. The proxy uplink sensing measurement is such as the proxy device sending a trigger frame and then receiving the NDP frame sent by the STA.

Taking the proxy device as an AP as an example, in the scenario where the AP performs sensing measurement as a proxy of STA, before the AP performs the proxy operation, the STA sends a first radio frame to the AP, and indicates to the AP through the first radio frame that it supports being proxied for performing sensing measurement. Optionally, the first radio frame can be a Probe Request frame, an Association Request frame, or a Multi-link Probe Request frame, etc.

The first radio frame includes the first sensing proxy information (Sensing By Proxy, SBP). The first sensing proxy information indicates whether the STA supports being represented by a proxy device to perform WLAN sensing measurement during the WLAN sensing measurement as a sensing initiator. That is, the first sensing proxy information indicates whether the STA supports being proxied by the AP for sensing measurement. It can be understood that in the multi-connection scenario, the first sensing proxy information is at the multi-connection level.

Since the STA does not have the function of communicating with multiple receiving ends at the same time when serving as a sensing initiator or a sensing transmitter, the AP needs to perform sensing measurement as a proxy of STA. Before the AP performs sensing measurement as a proxy of STA, the first sensing proxy information indicates the capability information whether the STA supports to be proxied, so that the AP determines whether to initiate the sensing measurement process as a proxy of STA according to the capability information, to improve the proxy measurement process. For example, if the STA supports being proxied for sensing measurement, the AP can initiate the sensing measurement. It can be understood that, if the STA is a device that supports multiple connections (for example, supports the 802.11be communication protocol), the first sensing proxy information indicates the capability information being proxied under each connection.

In the embodiments of the present disclosure, the STA sends a first radio frame, and the first sensing proxy information is carried in the first radio frame. The first sensing proxy information indicates whether the STA supports the proxy device to perform WLAN sensing measurement as a proxy of the STA, to improve the proxy measurement process. The embodiments of the present disclosure provide a manner of indicating whether the STA supports the proxy device to perform WLAN sensing measurement as a proxy of the STA.

Optionally, in an embodiment of the present disclosure, the first wireless frame includes at least one of a Probe Request frame, a Multi-link (ML) Probe Request frame, an Association Request frame, a Reassociation Request frame, and an Authentication Request frame.

When sending the above-mentioned first wireless frame to the AP, the first wireless frame indicates whether the STA supports the proxy device to perform WLAN sensing measurement as a proxy of the STA. It can be understood that, in addition to this, the target wireless frame may also include other forms, which are not specifically limited in the embodiments of the present disclosure.

Optionally, the first sensing proxy information is carried in an extended capability information element (extended capabilities) of the first wireless frame. As a second example, the format of the extended capabilities is shown in the following Table 1:

TABLE 1

| Information | Element | | extended |
|---|---|---|---|
| content | ID | Length | capabilities |
| Number of | 1 | 1 | variable |
| bytes (Octets) | | | |

Wherein, the content of the first sensing proxy information can be shown in Table 2 below:

TABLE 2

| Bit order | | |
|---|---|---|
| Bits) | information | notes |
| 98 | first sensing proxy | support sending SBP |
| | information (SBP) | request frame |

Wherein, the 98th bit of extended capabilities can be occupied: for example, “1” indicates support, and “0” indicates no support.

Referring to FIG. 5, the embodiment of the present disclosure further provides a communication method. Optionally, the method can be applied to a station STA, and the method can include the following step:

step 501, sending the first wireless frame during an initial association process with the access point AP.

The proxy device is an access point AP. The first wireless frame includes first sensing proxy information, the first sensing proxy information indicates whether the STA supports being represented by a proxy device to perform WLAN sensing measurement during the WLAN sensing measurement as a sensing initiator.

In the embodiment, “association” can refer to that an association connection for communication is established between the sensing initiator and the sensing receiver, and “non-association” can refer to that an association connection for communication is not established between the sensing initiator and the sensing receiver. In the initial association process with the access point AP, i.e., the process of initially establishing a communication connection with the access point, the first sensing proxy information indicates whether the STA supports the proxy device to perform WLAN sensing measurement as a proxy of the STA, to improve the proxy measurement process.

Referring to FIG. 6, the embodiment of the present disclosure further provides a communication method. Optionally, the method can be applied to a station STA, and the method can include the following steps.

Step 601, a second wireless frame sent by the AP is received.

The second radio frame may be a beacon frame, a probe response frame, etc.

Step 602, second sensing proxy information in the second wireless frame is obtained, wherein the second sensing proxy information indicates whether the AP supports to perform the WLAN sensing measurement as a proxy of STA during the WLAN sensing measurement.

In the embodiment, the second sensing proxy information indicates whether the AP supports to perform the WLAN sensing measurement as a proxy of STA during the WLAN sensing measurement, that is, the second sensing proxy information indicates whether the AP supports to perform sensing measurement as a proxy of STA. It can be understood that in a multi-connection scenario, the second sensing proxy information is at the multi-connection level.

If the second sensing proxy information indicates that the AP supports to perform the WLAN sensing measurement as a proxy of STA during the WLAN sensing measurement, after the first wireless frame is sent, the method further includes:
sending a third wireless frame to the AP, wherein the third wireless frame indicates that the AP performs the WLAN sensing measurement as a proxy of STA.

Optionally, the third radio frame may be a proxy request frame. When the STA and the AP notify each other of the proxy capability information respectively, and both support AP proxy sensing measurement, the STA may send a proxy request frame to the AP, to request the AP to perform WLAN sensing measurement as a proxy of STA.

In the embodiments of the present disclosure, the STA sends a first radio frame, and the first sensing proxy information is carried in the first radio frame. The first sensing proxy information indicates whether the STA supports the proxy device to perform WLAN sensing measurement as a proxy of the STA, to improve the proxy measurement process. The embodiments of the present disclosure provide a manner of indicating whether the STA supports the proxy device to perform WLAN sensing measurement as a proxy of the STA.

In the implementation of the present disclosure, the above-mentioned multiple embodiments can be executed separately or in combination.

For example, STA can execute step 101 to send the first radio frame and execute step 601 to receive the second radio frame of AP (there is no sequential time slot limitation for the two steps). If both STA and AP support the proxy device to perform WLAN sensing measurement as a proxy of STA, the third radio frame is sent to instruct the corresponding AP to perform WLAN sensing measurement as a proxy of STA. In one possible implementation, STA first sends the first radio frame to indicate that STA supports the proxy device to perform WLAN sensing measurement as a proxy of STA. After receiving the first radio frame to determine that STA supports the proxy device to perform WLAN sensing measurement as a proxy of STA, the AP reports the second radio frame to report whether the AP supports the proxy device to perform WLAN sensing measurement as a proxy of STA. In another possible implementation, STA sends the first radio frame after receiving the second radio frame sent by AP to determine that AP supports the proxy device to perform WLAN sensing measurement as a proxy of STA. In another possible implementation, STA sends the first radio frame and AP sends the second radio frame, and there is no time limit relationship and trigger relationship between the two.

For another example, the STA may not need to notify the AP whether it supports the proxy device to perform WLAN sensing measurement as a proxy of STA. When the STA receives the second radio frame sent by the AP to determine that the AP supports the proxy device to perform WLAN sensing measurement as a proxy of STA, it sends a third radio frame to instruct the corresponding AP to perform WLAN sensing measurement as a proxy of STA.

For another example, the STA may not need to know whether the AP supports the proxy device to perform WLAN sensing measurement as a proxy of STA. The STA performs step 101 to notify the AP that the STA supports the proxy device to perform WLAN sensing measurement as a proxy of STA through the first radio frame, and sends a third radio frame to instruct the corresponding AP to perform WLAN sensing measurement as a proxy of STA. In a possible implementation, if the message that the AP does not support the proxy device to perform WLAN sensing measurement as a proxy of STA is not received, the third radio frame is sent to instruct the corresponding AP to perform WLAN sensing measurement as a proxy of STA.

For another example, the STA may not need to notify the AP whether the STA supports the proxy device to perform WLAN sensing measurement as a proxy of STA, nor does it need to know whether the AP supports the proxy device to perform WLAN sensing measurement as a proxy of STA. The STA sends the third radio frame to instruct the corresponding AP to perform WLAN sensing measurement as a proxy of STA. In a possible implementation, the STA sends a third radio frame to instruct the corresponding AP to perform WLAN sensing measurement as a proxy of STA. If a message sent by the AP that it does not support the proxy device to perform WLAN sensing measurement as a proxy of STA is received, the message instructing the AP to perform WLAN sensing measurement as a proxy of STA is abandoned.

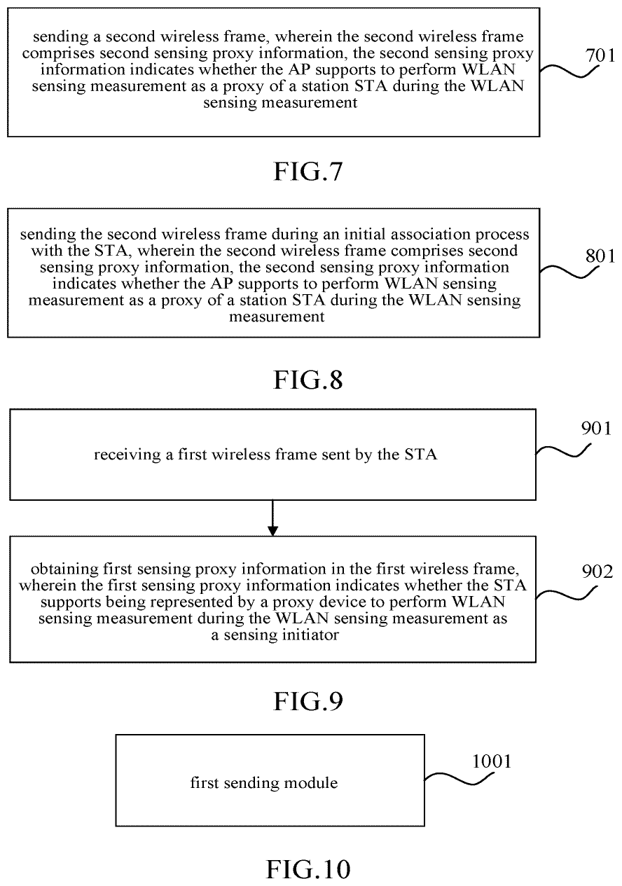

Referring to FIG. 7, the embodiment of the present disclosure also provides a communication method, which is applied to an access point AP, and the method includes:

step 701, sending a second wireless frame, wherein the second wireless frame includes second sensing proxy information, the second sensing proxy information indicates whether the AP supports to perform WLAN sensing measurement as a proxy of a station STA during the WLAN sensing measurement.

The architecture of WLAN sensing and the WLAN sensing process applied to the WLAN sensing measurement method provided by the embodiment of the present disclosure refer to the aforementioned first example, which will not be repeated here.

The proxy device performing WLAN sensing measurement as a proxy of STA may include at least one of proxy downlink sensing measurement and proxy uplink sensing measurement. The proxy downlink sensing measurement is such as the proxy device (such as AP) sending an NDPA frame and then sending an NDP frame. The proxy uplink sensing measurement is such as the proxy device sending a trigger frame and then receiving the NDP frame sent by the STA.

In the scenario where the AP performs sensing measurement as a proxy of STA, before the AP performs the proxy operation, the AP sends a second radio frame to the STA, and indicates to the STA whether it supports to perform WLAN sensing measurement as a proxy of STA during the WLAN sensing measurement process through the second radio frame. Optionally, the second radio frame can be a beacon frame, a probe response frame, an association response frame, etc.

The second radio frame includes second sensing proxy information (Sensing By Proxy, SBP). The second sensing proxy information indicates whether it supports to perform WLAN sensing measurement as a proxy of STA during the WLAN sensing measurement, that is, the second sensing proxy information indicates whether the AP supports to perform sensing measurement as a proxy of STA. It can be understood that in a multi-connection scenario, the second sensing proxy information is at a multi-connection level.

Since the STA does not have the function of communicating with multiple receiving ends at the same time when serving as a Sensing Initiator or Sensing Transmitter, the AP needs to perform sensing measurement as a proxy of STA. Before the AP performs sensing measurement as a proxy of STA, the second sensing proxy information indicates the capability information whether the AP supports to perform sensing measurement as a proxy of STA, so that the STA determines whether to request the AP to initiate the sensing measurement process as a proxy of STA according to the capability information, to improve the proxy measurement process. For example, if the AP supports to perform sensing measurement as a proxy of STA, the STA can request the AP to initiate the sensing measurement. It can be understood that, if the AP is a device that supports multiple connections (for example, supports the 802.11be communication protocol), the second sensing proxy information indicates the capability information of its proxy under each connection to initiate sensing measurement and feedback the sensing measurement result to the initiator.

In the embodiments of the present disclosure, the AP sends a second radio frame, the second sensing proxy information is carried in the second radio frame, and the second sensing proxy information indicates whether the AP supports to perform WLAN sensing measurement as a proxy of STA, to improve the proxy measurement process. The embodiment of the present disclosure provides a manner for indicating whether the AP supports to perform WLAN sensing measurement as a proxy of STA.

Optionally, in an embodiment of the present disclosure, the second wireless frame includes at least one of a Beacon frame, a Probe Response frame, a ML Probe Response frame, an Association response frame, a Reassociation response frame, and an Authentication response frame.

When the AP sends the above-mentioned second radio frame to the STA, the second radio frame indicates whether the AP supports to perform WLAN sensing measurement as a proxy of STA. It can be understood that, in addition to this, the target wireless frame may also include other forms, which are not specifically limited in the embodiments of the present disclosure.

Optionally, the second sensing proxy information is carried in the extended capabilities information element (extended capabilities) of the second wireless frame. As a third example, the extended capabilities format is shown in Table 3 below:

TABLE 3

| Information | Element | | extended |
|---|---|---|---|
| content | ID | Length | capabilities |
| Number of | 1 | 1 | variable |
| bytes(Octets) | | | |

Wherein, the content of the second sensing proxy information can be shown in Table 4 below:

TABLE 4

| Bit order | | |
|---|---|---|
| Bits | information | notes |
| 99 | second sensing proxy | initiate WLAN sensing |
| | information (SBP) | measurement process as |
| | | a proxy device, and reply |
| | | the sensing measurement |
| | | result to the initiator |

Wherein, the second sensing proxy information can occupy the 99th bit of extended capabilities, for example, “1” indicates support, “0” indicates no support; and in the case of support, the AP will initiate the WLAN sensing measurement process as a proxy device, and reply the sensing measurement result to the initiator (STA).

Referring to FIG. 8, the embodiment of the present disclosure further provides a communication method. Optionally, the method can be applied to an access point, and the method can include the following step:

step 801, sending the second wireless frame during an initial association process with the STA.

The second wireless frame includes second sensing proxy information, the second sensing proxy information indicates whether the AP supports to perform WLAN sensing measurement as a proxy of a station STA during the WLAN sensing measurement.

In the embodiment, “association” can refer to that an association connection for communication is established between the sensing initiator and the sensing receiver, and “non-association” can refer to that an association connection for communication is not established between the sensing initiator and the sensing receiver. In the initial association process with the station, i.e., the process of initially establishing a communication connection with the station, the second sensing proxy information indicates whether the AP supports to perform WLAN sensing measurement as a proxy of STA, the proxy measurement process is improved.

Referring to FIG. 9, the embodiment of the present disclosure further provides a communication method. Optionally, the method can be applied to an access point, and the method can include the following steps.

Step 901, a first wireless frame sent by the STA is received.

In the scenario where the AP performs sensing measurement as a proxy of STA, before the AP performs the proxy operation, the AP receives the first wireless frame sent by the STA. Optionally, the first wireless frame may be a Probe Request frame, an Association Request frame, etc.

Step 902, first sensing proxy information in the first wireless frame is obtained, wherein the first sensing proxy information indicates whether the STA supports being represented by a proxy device to perform WLAN sensing measurement during the WLAN sensing measurement as a sensing initiator.

The first radio frame includes the first sensing proxy information (Sensing By Proxy; SBP). The first sensing proxy information indicates whether the STA supports being represented by a proxy device to perform WLAN sensing measurement during the WLAN sensing measurement as a sensing initiator. That is, the first sensing proxy information indicates whether the STA supports being proxied by the AP for sensing measurement. The AP determines whether to initiate the sensing measurement process as a proxy of STA according to the capability information, to improve the proxy measurement process.

If the first sensing proxy information indicates that the STA supports being represented by a proxy device to perform WLAN sensing measurement during the WLAN sensing measurement as a sensing initiator, after the second wireless frame is sent, the method further includes:
receiving a third wireless frame sent by the STA:
in response to the third wireless frame, performing the WLAN sensing measurement as a proxy of STA.

Optionally, the third radio frame may be a proxy request frame. When the STA and the AP notify each other of the proxy capability information respectively, and both support AP proxy sensing measurement, the AP may receive the proxy request frame and perform WLAN sensing measurement as a proxy of STA according to the proxy request frame.

In the embodiments of the present disclosure, the AP sends a second radio frame, the second sensing proxy information is carried in the second radio frame, and the second sensing proxy information indicates whether the AP supports to perform WLAN sensing measurement as a proxy of STA, the proxy measurement process is improved. The embodiment of the present disclosure provides a manner for indicating whether the AP supports to perform WLAN sensing measurement as a proxy of STA.

In the implementation of the present disclosure, the above-mentioned multiple embodiments may be executed separately or in combination.

For example, the AP may execute step 801 to send the second radio frame, and execute step 901 to receive the first radio frame (there is no sequential time slot limitation for the two steps). The STA determines that both the STA and the AP support the proxy device to perform WLAN sensing measurement as a proxy of STA, the third radio frame is received to execute the AP to perform WLAN sensing measurement as a proxy of STA. In one possible implementation, the AP first reports the second radio frame and then receives the first radio frame. That is, the STA sends the first radio frame after determining that the AP supports the proxy device to perform WLAN sensing measurement as a proxy of the STA. In another possible implementation, the AP reports the second radio frame after receiving the first radio frame. That is, the AP sends the second radio frame after determining that the STA supports the proxy device to perform WLAN sensing measurement as a proxy of the STA. In another possible implementation, the STA sends the first radio frame and the AP sends the second radio frame, and there is no time limit relationship and trigger relationship between the two.

For another example, the AP may not need to know that the proxy device performs WLAN sensing measurement as a proxy of the STA through the first radio frame (that is, the AP does not perform step 901): that is, the AP sends the second radio frame to report that the AP supports the proxy device to perform WLAN sensing measurement as a proxy of STA. Further, in the scenario where the STA supports the proxy device to perform WLAN sensing measurement as a proxy of the STA, the AP receives the third radio frame sent by the STA to instruct the corresponding AP to perform WLAN sensing measurement as a proxy of STA.

For another example, the AP receives the third radio frame sent by the STA to instruct the corresponding AP to perform WLAN sensing measurement as a proxy of STA. In the scenario where the AP does not support STA to perform WLAN sensing measurement, a feedback frame is sent to report that the AP does not support STA to perform WLAN sensing measurement.

For another example, the AP can execute step 901 to receive a first wireless frame: in response to determining that the STA supports the proxy device to perform WLAN sensing measurement as a proxy of STA, if the AP supports to perform WLAN sensing measurement as a proxy of STA, the AP does not need to send a second wireless frame. That is, according to the communication protocol or default settings, the AP supports to perform WLAN sensing measurement as a proxy of STA by default. In the scenario where the STA does not receive a feedback frame that the AP does not support to perform WLAN sensing measurement as a proxy of STA, the AP receives a third wireless frame sent by the STA and performs WLAN sensing measurement as a proxy of STA.

For another example, the AP can execute step 901 to receive a first wireless frame: in response to determining that the STA supports the proxy device to perform WLAN sensing measurement as a proxy of STA, if the AP does not support to perform WLAN sensing measurement as a proxy of STA, a feedback frame is sent to notify the STA.

Based on the same principle as the method provided in the embodiments of the present disclosure, the embodiment of the present disclosure also provides a station STA, referring to FIG. 10, the station includes:
a first sending module 1001, configured to send a first wireless frame, wherein the first wireless frame includes first sensing proxy information, the first sensing proxy information indicates whether the STA supports being represented by a proxy device to perform WLAN sensing measurement during the WLAN sensing measurement as a sensing initiator.

Optionally, in an embodiment of the present disclosure, the first wireless frame includes at least one of a Probe Request frame, a Multi-link (ML) Probe Request frame, an Association Request frame, a Reassociation Request frame, and an Authentication Request frame.

Optionally, in an embodiment of the present disclosure, the first sensing proxy information is carried in an extended capability information element of the first wireless frame.

Optionally, in an embodiment of the present disclosure, the sending module includes:
a first sending submodule, configured to send the first wireless frame during an initial association process with the access point AP.

Optionally, in an embodiment of the present disclosure, the station includes:
a first receiving module, configured to receive a second wireless frame sent by an AP:
an information acquisition module, configured to acquire second sensing proxy information in the second wireless frame, wherein the second sensing proxy information indicates whether the AP supports to perform the WLAN sensing measurement as a proxy of STA during the WLAN sensing measurement.

Optionally, in an embodiment of the present disclosure, the station also includes:
a second sending module, configured to send a third wireless frame to the AP when the second sensing proxy information indicates that the AP supports to perform the WLAN sensing measurement as a proxy of STA during the WLAN sensing measurement, wherein the third wireless frame indicates that the AP performs the WLAN sensing measurement as a proxy of STA.

In the embodiments of the present disclosure, the first sending module 1001 sends a first wireless frame, the first sensing proxy information is carried in the first wireless frame. The first sensing proxy information indicates whether the STA supports the proxy device to perform WLAN sensing measurement as a proxy of the STA, to improve the proxy measurement process.

The embodiment of the present disclosure also provides a communication apparatus, applied to a station STA, and the apparatus includes:
a fourth sending module, configured to send a first wireless frame, wherein the first wireless frame includes first sensing proxy information, the first sensing proxy information indicates whether the STA supports being represented by a proxy device to perform WLAN sensing measurement during the WLAN sensing measurement as a sensing initiator.

The apparatus also includes other modules of the station in the aforementioned embodiment, which are not repeated here.

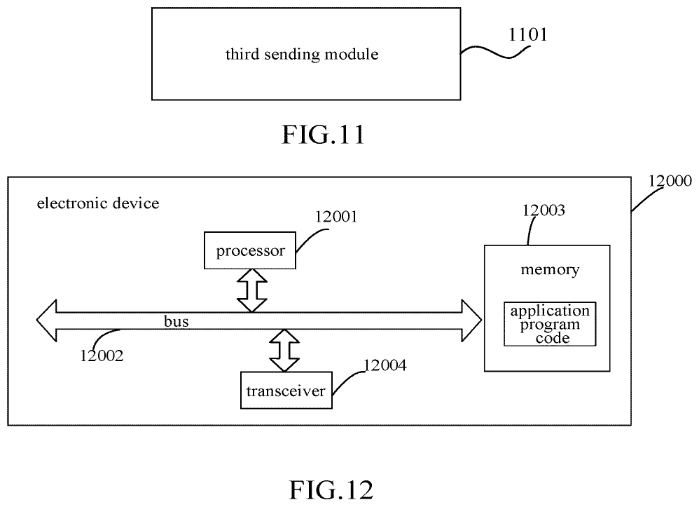

Referring to FIG. 11, the embodiment of the present disclosure also provides an access point AP, including:
a third sending module 1101, configured to send a second wireless frame, wherein the second wireless frame includes second sensing proxy information, the second sensing proxy information indicates whether the AP supports to perform WLAN sensing measurement as a proxy of a station STA during the WLAN sensing measurement.

Optionally, in an embodiment of the present disclosure, the second wireless frame includes at least one of a Beacon frame, a Probe Response frame, a ML Probe Response frame, an Association response frame, a Reassociation response frame, and an Authentication response frame.

Optionally, in an embodiment of the present disclosure, the second sensing proxy information is carried in an extended capability information element of the second wireless frame.

Optionally, in an embodiment of the present disclosure, the third sending module includes:
a second sending submodule, configured to send the second wireless frame during an initial association process with the STA.

Optionally, in an embodiment of the present disclosure, the access point includes:
a second receiving module, used to receive a first wireless frame sent by the ST:
an acquisition module, configured to acquire first sensing proxy information in the first wireless frame, wherein the first sensing proxy information indicates whether the STA supports being represented by a proxy device to perform WLAN sensing measurement during the WLAN sensing measurement as a sensing initiator.

Optionally, in an embodiment of the present disclosure, the access point also includes:
a third receiving module, configured to receive a third wireless frame sent by the STA when the first sensing proxy information indicates that the STA supports being represented by a proxy device to perform WLAN sensing measurement during the WLAN sensing measurement as a sensing initiator:
perform the WLAN sensing measurement as a proxy of STA in response to the third wireless frame.

In the embodiments of the present disclosure, the third sending module 1101 sends a second wireless frame, the second sensing proxy information is carried in the second radio frame, and the second sensing proxy information indicates whether the AP supports to perform WLAN sensing measurement as a proxy of STA, the proxy measurement process is improved.

The embodiment of the present disclosure also provides a communication apparatus, applied to an access point AP, and the apparatus includes:
a fifth sending module, configured to send a second wireless frame, wherein the second wireless frame includes second sensing proxy information, the second sensing proxy information indicates whether the AP supports to perform WLAN sensing measurement as a proxy of a station STA during the WLAN sensing measurement.

The apparatus also includes other modules of the access point in the aforementioned embodiment, which will not be repeated here.

In an optional embodiment, the embodiment of the present disclosure also provides an electronic device, as shown in FIG. 12, the electronic device 12000 shown in FIG. 12 can be a server, including: a processor 12001 and a memory 12003. The processor 12001 and the memory 12003 are connected, such as through a bus 12002. Optionally, the electronic device 12000 may also include a transceiver 12004. It should be noted that in actual applications, the transceiver 12004 is not limited to one, and the structure of the electronic device 12000 does not constitute a limitation on the embodiments of the present disclosure.

The processor 12001 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components or any combination thereof. It can implement or execute various example logic blocks, modules and circuits described in conjunction with the content of the present disclosure. The processor 12001 may also be a combination that implements computing functions, such as a combination of one or more microprocessors, a combination of a DSP and a microprocessor, etc.

The bus 12002 may include a path to transmit information between the above components. The bus 12002 may be a PCI (Peripheral Component Interconnect) bus or an EISA (Extended Industry Standard Architecture) bus, etc. The bus 12002 can be divided into an address bus, a data bus, a control bus, etc. For ease of representation, only one thick line is used in FIG. 12, but it does not mean that there is only one bus or one type of bus.

The memory 12003 may be a ROM (Read Only Memory) or other types of static storage devices that can store static information and instructions, a RAM (Random Access Memory) or other types of dynamic storage devices that can store information and instructions, or an EEPROM (Electrically Erasable Programmable Read Only Memory), a CD-ROM (Compact Disc Read Only Memory) or other optical disk storage, optical disk storage (including compressed optical disk, laser disk, optical disk, digital versatile disk, Blu-ray disk, etc.), a disk storage medium or other magnetic storage device, or any other medium that can be used to carry or store the desired program codes in the form of instructions or data structures and can be accessed by a computer, but is not limited thereto.

The memory 12003 is used to store the application codes for executing the solution of the disclosure, and is controlled by the processor 12001 to execute. The processor 12001 is used to execute the application codes stored in the memory 12003, to implement the content shown in the aforementioned method embodiment.

The electronic devices include but are not limited to: mobile terminals, such as mobile phones, laptops, digital broadcast receivers, PDAs (personal digital assistants), PADs (tablet computers), PMPs (portable multimedia players), vehicle-mounted terminals (such as vehicle-mounted navigation terminals), etc., and fixed terminals such as digital TVs, desktop computers, etc. The electronic device shown in FIG. 12 is only an example and should not impose any restrictions on the functions and scope of use of the embodiments of the present disclosure.

The server provided in the present disclosure may be an independent physical server, or a server cluster or distributed system composed of a plurality of physical servers, or a cloud server that provides basic cloud computing services such as cloud services, cloud databases, cloud computing, cloud functions, cloud storage, network services, cloud communications, middleware services, domain name services, security services, CDN, and big data and artificial intelligence platforms. The terminal may be a smart phone, a tablet computer, a laptop computer, a desktop computer, a smart speaker, a smart watch, etc., but is not limited thereto. The terminal and the server may be directly or indirectly connected via wired or wireless communication, which is not limited in the present disclosure.

The embodiments of the present disclosure provide a computer-readable storage medium, on which a computer program is stored, and when it is run on a computer, the computer can execute the corresponding contents in the aforementioned method embodiments.

It should be understood that, although the steps in the flowchart of the accompanying drawings are displayed in sequence as indicated by the arrows, these steps are not necessarily executed in the order indicated by the arrows. Unless otherwise specified in this document, the execution of these steps is not strictly limited in order, and they can be executed in other orders. Moreover, at least part of the steps in the flowchart of the accompanying drawings may include multiple sub-steps or multiple stages, and these sub-steps or stages are not necessarily executed at the same time, but can be executed at different times, and their execution order is not necessarily sequential, but can be executed in turn or alternately with other steps or at least part of the sub-steps or stages of other steps.

It should be noted that, the computer-readable medium of the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus or device, or any combination of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in conjunction with an instruction execution system, apparatus, or device. In the present disclosure, a computer-readable signal medium may include a data signal propagated in a baseband or as part of a carrier wave, in which a computer-readable program code is carried. Such propagated data signals may take a variety of forms, including but not limited to electromagnetic signals, optical signals, or any suitable combination of the above. A computer-readable signal medium may also be any computer-readable medium other than a computer-readable storage medium, which may send, propagate, or transmit a program for use by or in conjunction with an instruction execution system, apparatus, or device. The program code contained on the computer-readable medium can be transmitted by any appropriate medium, including but not limited to: wires, optical cables, RF (radio frequency), etc., or any suitable combination of the above.

The above-mentioned computer-readable medium may be contained in the above-mentioned electronic device: or it may exist separately without being assembled into the electronic device.

The above-mentioned computer-readable medium carries one or more programs, and when the above-mentioned one or more programs are executed by the electronic device, the electronic device executes the methods shown in the above-mentioned embodiments.

According to one aspect of the present disclosure, a computer program product or computer program is provided. The computer program product or computer program includes computer instructions, and the computer instructions are stored in a computer-readable storage medium. The processor of the computer device reads the computer instructions from the computer-readable storage medium, and the processor executes the computer instructions, so that the computer device executes the methods provided in the above-mentioned various optional implementations.

The computer program code for performing the operation of the present disclosure can be written in one or more programming languages or a combination thereof, and the above-mentioned programming languages include object-oriented programming languages-such as Java, Smalltalk, C++, and also conventional procedural programming languages-such as “C” language or similar programming languages. The program code may be executed entirely on the user's computer, partially on the user's computer, as a stand-alone software package, partially on the user's computer and partially on a remote computer, or entirely on a remote computer or server. In the case of a remote computer, the remote computer may be connected to the user's computer through any type of network, including a local area network (LAN) or a wide area network (WAN), or may be connected to an external computer (e.g., connected through the Internet using an Internet service provider).

The flowcharts and block diagrams in the accompanying drawings illustrate the possible implementation architectures, functions, and operations of the systems, methods, and computer program products according to various embodiments of the present disclosure. In this regard, each box in the flowchart or block diagram may represent a module, a program segment, or a portion of codes, which contains one or more executable instructions for implementing a specified logical function. It should also be noted that, in some alternative implementations, the functions marked in the box may also occur in an order different from that marked in the accompanying drawings. For example, two boxes represented in succession may actually be executed substantially in parallel, and they may sometimes be executed in a reverse order, depending on the functions involved. It should also be noted that each box in the block diagram and/or flowchart, and the combination of boxes in the block diagram and/or flowchart, can be implemented by a dedicated hardware-based system that performs the specified function or operation, or can be implemented by a combination of dedicated hardware and computer instructions.

The modules involved in the embodiments described in the present disclosure can be implemented by software or by hardware. The name of the module does not constitute a limitation on the module itself in some cases. For example, module A can also be described as “module A for performing operation B”.

The above description is only a preferred embodiment of the present disclosure and an explanation of the adopted technical principles. Those skilled in the art should understand that, the scope of disclosure involved in the present disclosure is not limited to the technical solutions formed by a specific combination of the above technical features, but also should cover other technical solutions formed by any combination of the above technical features or their equivalent features without departing from the above concept of the disclosure, for example, technical solutions formed by interchanging the above features with technical features (but not limited to) with similar functions disclosed in the present disclosure.

1. A communication method, performed by a station (STA), and the method comprising:
sending a first wireless frame, wherein the first wireless frame comprises first sensing proxy information, the first sensing proxy information indicating whether the STA supports a wireless local area network (WLAN) sensing measurement performed by a proxy device of the STA when the STA serves as a sensing initiator during the WLAN sensing measurement.

2. The communication method according to claim 1, wherein the first wireless frame comprises at least one of a Probe Request frame, a Multi-link (ML) Probe Request frame, an Association Request frame, a Reassociation Request frame, or an Authentication Request frame.

3. The communication method according to claim 2, wherein the first sensing proxy information is carried in an extended capability information element of the first wireless frame.

4. The communication method according to claim 1, wherein the proxy device is an access point (AP), and sending the first wireless frame comprises:
sending the first wireless frame during an initial association process with the access point (AP).

5. The communication method according to claim 1, comprising:
receiving a second wireless frame sent by an AP; and
obtaining second sensing proxy information in the second wireless frame, wherein the second sensing proxy information indicates whether the AP supports to perform the WLAN sensing measurement as the proxy device of the STA during the WLAN sensing measurement.

6. The communication method according to claim 5, wherein the second sensing proxy information indicates that the AP supports to perform the WLAN sensing measurement as the proxy device of the STA during the WLAN sensing measurement, and after the first wireless frame is sent, the method further comprises:
sending a third wireless frame to the AP, wherein the third wireless frame indicates that the AP performs the WLAN sensing measurement as the proxy device of the STA.

7. A communication method, performed by an access point (AP), and the method comprising:
sending a second wireless frame, wherein the second wireless frame comprises second sensing proxy information, the second sensing proxy information indicating whether the AP supports to perform a wireless local area network (WLAN) sensing measurement as a proxy device of a station (STA) during the WLAN sensing measurement.

8. The communication method according to claim 7, wherein the second wireless frame comprises at least one of a Beacon frame, a Probe Response frame, a ML Probe Response frame, an Association response frame, a Reassociation response frame, or an Authentication response frame.

9. The communication method according to claim 8, wherein the second sensing proxy information is carried in an extended capability information element of the second wireless frame.

10. The communication method according to claim 7, wherein sending the second wireless frame comprises:
sending the second wireless frame during an initial association process with the STA.

11. The communication method according to claim 7, comprising:
receiving a first wireless frame sent by the STA;
obtaining first sensing proxy information in the first wireless frame, wherein the first sensing proxy information indicates whether the STA supports being represented by the proxy device to perform the WLAN sensing measurement during the WLAN sensing measurement as a sensing initiator.

12. The communication method according to claim 11, wherein the first sensing proxy information indicates that the STA supports being represented by the proxy device to perform the WLAN sensing measurement during the WLAN sensing measurement as the sensing initiator, and after the second wireless frame is sent, the method further comprises:
receiving a third wireless frame sent by the STA;
in response to the third wireless frame, performing the WLAN sensing measurement as the proxy device of STA.

13-14. (canceled)

15. A communication apparatus, applied to a station (STA), and the apparatus comprising:
a processor; and
a memory, having a computer program stored thereon,
wherein the processor is configured to send a first wireless frame, wherein the first wireless frame comprises first sensing proxy information, the first sensing proxy information indicating whether the STA supports a wireless local area network (WLAN) sensing measurement performed by a proxy device of the STA when the STA serves as a sensing initiator during the WLAN sensing measurement.

16. A communication apparatus, applied to an access point (AP), and the apparatus comprising:
a processor; and
a memory, having a computer program stored thereon,
wherein the processor is configured to perform the communication method according to claim 7.

17. An electronic device, comprising a memory, a processor, and a computer program stored on the memory and executable on the processor, wherein the processor implements the method described in claim 1 when executing the program.

18. A non-transitory computer-readable storage medium, wherein a computer program is stored on the computer-readable storage medium, the computer program implements the method described in claim 1 when executed by the processor.

19. The communication apparatus according to claim 15, wherein the first wireless frame comprises at least one of a Probe Request frame, a Multi-link (ML) Probe Request frame, an Association Request frame, a Reassociation Request frame, or an Authentication Request frame.

20. The communication apparatus according to claim 19, wherein the first sensing proxy information is carried in an extended capability information element of the first wireless frame.

21. The communication apparatus according to claim 15, wherein the processor is further configured to:
send the first wireless frame during an initial association process with an access point (AP).

22. The communication apparatus according to claim 15, wherein the processor is further configured to:
receive a second wireless frame sent by an AP; and
obtain second sensing proxy information in the second wireless frame, wherein the second sensing proxy information indicates whether the AP supports to perform the WLAN sensing measurement as the proxy device of STA during the WLAN sensing measurement.
